(19) United States
(12) Patent Application Publication
(10) Pub. No.: US 2008/0085342 A1
(43) Pub. Date: Apr. 10, 2008

(54) Method Of Serving A Slushy Drink And A Product For Use In Such

(76) Inventors: Gary Norman Binley, Bangkok (TH); Alan Ingram, Bedfordshire (GB); Daniel Matthew Mayes, Bedfordshire (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/632,877

(22) PCT Filed: Jun. 20, 2005
(86) PCT No.: PCT/EP05/06697

§ 371 Date: Jan. 19, 2007

(30) Foreign Application Priority Data
Jul. 19, 2004 (EP) 04254314.0

(51) Int. Cl. B65D 85/72; A23L 3/36

(52) U.S. Cl. 426/66; 426/115; 426/393

(57) ABSTRACT

An improved method of serving a slushy drink is provided wherein a manufactured slush is filled into a container (I) to occupy at least 70% of the volume of the container and then hardened to produce a frozen product in the container. The frozen product is then transported through a cold chain to a retail outlet. Following warming to a temperature of between −14 and −5° C., the frozen product is transformed into the slushy drink, preferably by deforming the container.

### FIELD OF THE INVENTION

The present invention relates to an improved method of serving a slushy drink such as a frappe, smoothie or milkshake. The present invention also relates to a frozen product in a container which may be served as a slushy drink.

### BACKGROUND OF THE INVENTION

Frozen dairy-based drinks such as milkshakes and non-dairy, fruit-flavoured slushes and frappes have been popular for many decades. Recent years have seen the emergence of a new category of popular frozen drinks which are fruit-based and commonly referred to as “smoothies”. All of these products have a slushy texture owing to the presence of a dispersion of ice particles.

In order to produce the required fine dispersion of ice particles, slushy drinks are usually freshly prepared immediately prior to consumption (for example in fast food outlets). For milkshakes, slushes and frappes the preparation often involves simultaneous agitation and freezing in specialised freezers and, for milkshakes, the agitation may involve whipping to provide the necessary aeration. The air whipped into the milkshake gives the product the creaminess and mouthfeel that the consumer has come to expect for milkshake products. For smoothies the preparation often involves blending fresh fruit with ice cubes in a high-speed mixer (e.g. domestic food processor). These preparation methods require the use of special apparatus and machines and require considerable intervention by the retailer. As a result, conventional methods of serving a slushy drink are inconvenient, prone to hygiene problems and susceptible to the variable culinary skill and competence of the retailer.

To address some of the drawbacks of the conventional methods mentioned above, the use of pre-packaged frozen products as precursors for the manufacture of slushy drinks has been proposed in the past.

U.S. patent application 2001/0046545 provides a frozen slushy drink in a squeezable pouch immediately consumable by the consumer after removal from a home freezer. Specific ingredients (such as calcium salts and glycerol) and processes are required to allow the frozen drink to be easily broken up upon manual manipulation of the squeezable pouch after removal of the product from the home freezer.

Also, pre-packed alcoholic slushy drinks such as those disclosed in international patent application WO 96/11678 have been successfully marketed for around a decade. The products are said to freeze to produce slushy cocktails when placed at freezer temperatures of −5 to 20° F. (−20.6 to −6.7° C.) for 3-6 hours. The high alcohol content (>3.5%) in the beverages allows for shelf stability and assists in depressing the freezing point of the beverages such that they do not become solid during the limited storage time in the freezer. After the frozen beverage is removed from the freezer, the consumer massages the package gently and pours it into a glass for consumption. Critical to the function of the beverage is the presence of a specific stabilising system of guar gum and locust bean gum.

U.S. Pat. No. 3,479,187 describes thixotropic milkshake compositions which are frozen and aerated at 18 to 20° F. (−7.8 to −6.7° C.), packaged in cups, placed in storage at 0 to −20° F. (−17.8 to −28.9° C.) to harden for transportation to distribution centres and then tempered to 20° F. (−6.7° C.) for consumption from vending equipment. Upon mild shaking the milkshake is said to be transformed from a rigid state to a flowable state so it can be drawn through a straw. Apart from the fact that such technology absolutely requires low overrun, specific types and amounts of sweeteners and a specific content of milk solids, the need for shaking in order to effect transformation of the product to a flowable state requires that the cups can only be part-filled. The use of part-filled containers is both uneconomical and inconvenient as it results in high transport costs per unit mass of product and requires excessive storage volume per unit mass of product.

There is thus a need for a hygienic, economical and convenient method for serving a slushy drink, compatible with a wide-range of formulations.

It has been found that it is possible to achieve such a goal by carefully controlling the way in which a frozen product is packaged, distributed and stored, especially when the product is transformed into a drinkable state in a specific manner.

### TESTS AND DEFINITIONS

### Slush

A slush is defined as a pumpable semi-solid comprising a dispersion of ice in a liquid. Such materials are well-known to those skilled in the art as they are used, for example, in the manufacture of certain water ice products.

### Slushy Drink

A slushy drink is defined as a drinkable semi-solid comprising a dispersion of ice in a liquid. Typical examples are milkshakes, flavoured slushes, frappes and fruit-smoothies.

### Manual Deformation

Manual deformation of a container is defined as the act of deforming the container using the force of the hands alone, i.e. in the absence of any levers, tools or mechanisms.

By squeezing is meant the act of gripping a deformable container in one or both hands and applying hand pressure such that the container is compressed in at least one dimension.

By kneading is meant the act of working a flexible container by folding and/or pressing it between the hands of a user and/or between the hand(s) of the user and a stationary surface (such as a table top).

### Average Molecular Weight

The average molecular weight for a mixture of freezing point depressants (fpds) is defined by the number average molecular weight <M>ₙ (equation 1). Where wᵢ is the mass of species i, Mᵢ is the molar mass of species i and Nᵢ is the number of moles of species i of molar mass Mᵢ.

$$< M {>}_{n} = \frac{\sum {w}_{i}}{\sum ( {w}_{i} / {M}_{i} )} = \frac{\sum {N}_{i} {M}_{i}}{\sum {N}_{i}} \qquad Equation 1$$

### Freezing Point Depressants

Freezing point depressants (fpds) as defined in this invention consist in:
Monosaccharides and disaccharides.
Oligosaccharides containing from 3 to ten monosaccharide units joined in glycosidic linkage.
Corn syrups with a dextrose equivalent (DE) of greater than 20 preferably >40 and more preferably >60. Corn syrups are complex multi-component sugar mixtures and the dextrose equivalent is a common industrial means of classification. Since they are complex mixtures their number average molecular weight <M>, can be calculated from the equation below. (Journal of Food Engineering, 33 (1997) 221-226).

$$D E = \frac{18016}{< M {>}_{n}}$$

Erythritol, arabitol, glycerol, xylitol, sorbitol, mannitol, lactitol and malitol.

### Overrun

Overrun is defined by the following equation

$$O R = \frac{\begin{matrix}volume of frozen aerated product - \\ volume of premix at ambient temp\end{matrix}}{volume of premix at ambient temp} \times 100$$

It is measured at atmospheric pressure.

### Ice Particle Size Distribution

The distribution of ice particles is quantified in terms of the number population distribution of area size. Area size is the preferred quantity as, for non-spherical, anisotropic and irregular 3-D objects (such as ice particles) imaged in two dimensions, it more accurately relates to bulk mechanical properties than one-dimensional quantities such as particle length.

The ice particle size distribution of a frozen product is measured as follows.

### Sample Preparation

All equipment, reagents and products used in sample preparation are equilibrated to a temperature of −10° C. for at least 10 hours prior to use.

A 10 g sample of the frozen product is taken and added to 50 cm³ of a 20% aqueous solution of ethanol and gently agitated for 30 s to disperse the ice particles. The whole ice/ethanol/water mix is then gently poured into a 10 cm diameter petri dish and agitated slightly to evenly disperse the ice particles in the dish. After 3 s (to allow for cessation of particle movement) an image is captured.

Ten replicate samples are taken for each product.

### Imaging

Images are acquired using a domestic digital camera (e.g. Sony DXC 930P) with its macro-lens assembly as supplied. This is found to provide sufficient magnification to reliably image particles with a size from 0.2 mm to greater than 50 mm. For imaging, the petri dish containing the sample is placed on a black background and illuminated at low angle.

### Analysis

Image analysis is conducted using KS RUN image analysis software to determine the area size of each particle in the image. User intervention is required to remove from the image: the edge of the petri dish (when in the image), air bubbles, residual undispersed syrup, and connected ice particles. Of these features, only the apparent connection between ice particles is relatively frequent.

The 10 samples taken allow for the sizing of at least 500 particles for each product characterised.

### Flow Rate

The flow rate of a product in a container through a straw is defined as the mass flow rate when a first end (i.e. inlet) of the straw is in contact with the centre of the product at a pressure of 1 atm (absolute) and a second end (i.e. outlet) of the straw has there applied a pressure of −0.28 atm (gauge).

### BRIEF DESCRIPTION OF THE INVENTION

According to a first aspect of the invention there is provided a method of serving a slushy drink comprising the steps of:
(a) Manufacturing a slush.
(b) Filling a container with the slush to a level of at least 70%, preferably at least 80% of the capacity of the container, more preferably at least 90%.
(c) Hardening the slush at a hardening location to produce a frozen product in the container.
(d) Transporting the frozen product in the container from the hardening location through a cold chain to a retail outlet.
(e) Warming the product in the container at the retail outlet to a temperature, T, of between −14 and −5° C.
(f) Transforming the frozen product in the container into the slushy drink.

We have found that such a method provides for the hygienic and convenient serving of a slushy drink using conventional cold chains, which are arranged to prevent a frozen product from warming to a temperature wherein its structure and/or quality is irreversibly damaged. Preferably the cold-chain is arranged to prevent the frozen product from warming to a temperature warmer than T, more preferably −17° C., and even more preferably −20° C.

“Hardening” as used herein means cooling the slush until it is stiff enough to hold its own shape. It is a well-known term in the art and typical processes for hardening are described in “Ice Cream”, 4^{th} Edn, (W. S. Arbuckle, 1986, van Nostrand Renhold Co Inc, NY) at page 262. Usually the hardening location is remote from the retail outlet.

The temperature, T, employed in step (e) is warmer than that of conventional home freezers and retail cabinets which operate at around −18° C. or below. This allows for the use of a wider range of formulations by removing the requirement of some prior-art systems for specific soft formulations, e.g. achieved through the use of expensive calcium salts, alcohols, sugar alcohols and/or locust bean gum. Also, we have found that flexible and deformable containers tend to be uncomfortably cold to handle at the low temperatures of conventional retail cabinets and home freezers.

The temperature T must not be too high, however, otherwise the product structure deteriorates. Preferably T is between −12 and −6° C., more preferably between −11 and −7° C. Preferably the product is warmed by tempering in an environment having an air temperature that is held substantially constant about T, e.g. by means of a freezer cabinet operating at T. Preferably the product is tempered for at least 5 hours, more preferably at least 8 hours and even more preferably between 12 hours and 90 days, prior to consumption.

Preferably, the frozen product is transformed into the slushy drink in step (f) by deforming the container. Preferably, also the container is deformable by hand pressure. Preferably deformation of the container requires no special tools or appliances and is performed manually.

The use of deformation of the container to transform the solid frozen product to a drinkable state in step (f) allows for more complete filling of containers than prior art methods that require stirring or shaking of the container. In addition, we have surprisingly found that manual deformation of the product in the container transforms the product into a slushy drink much more rapidly than shaking the container or even directly stirring the product. The most efficient modes of deformation have been found to be squeezing and/or kneading. Owing to the relative efficiency of deformation as a means of transformation, it is possible to employ frozen products which remain relatively rigid and therefore structurally stable for extended periods (e.g. for at least 30 days) at a temperature ≦T. which products would otherwise require long periods (i.e. in excess of 4 minutes) of agitation (e.g. stirring) to effect transformation to a drinkable state.

In a preferred embodiment step (a) is achieved by a process comprising the steps of:
(i) Providing an aqueous syrup comprising freezing point depressants.
(ii) Providing ice particles.
(iii) Combining the syrup with the ice particles to form the slush.
(iv) Preferably reducing the ice particle size.

Slushy drinks made by such a process are found to provide an authentic freshly-made slush texture, with orally detectable ice particles, while displaying excellent drinkability when served using the methods of this invention. Such products obtained and/or obtainable by the process are also encompassed by the present invention. Preferably step (ii) is achieved by a fragmented ice maker such as that described in U.S. Pat. No. 4,569,209.

Preferably step (iv) is achieved by passing the slush through a constriction of a size, d, less than 5 mm, preferably of between 0.5 and 3 mm. This allows for in-line reduction of particle size and may comprise, for example, passing the slush through a pump comprising an outlet of size d, and/or passing the slush between parallel plates separated by a distance d and wherein one of the plates rotates relative to the other.

It is preferably that during step (iii) the syrup has a temperature of less than −1° C., more preferably between −5 and −15° C.; in order to prevent melting and sintering of the ice particles. In a preferred embodiment step (iii) is achieved by freezing a syrup premix to such a temperature in a scraped surface heat exchanger (standard ice cream freezer) and then feeding the particulate ice into the frozen syrup exiting the scraped surface heat exchanger e.g. by means of a fruit-feeder.

Preferably also the syrup contains freezing point depressants in an amount from 30 to 60%, more preferably from 35 to 50%. It is also preferred that the freezing point depressants have a number average molecular weight of below 275 g mol⁻¹ , preferably below 250, even more preferably between 210 and 245 g mol⁻¹. In order to minimise off-flavours it is preferable that the freezing point depressants consist of at least 98% by weight of mono-, di- and oligosaccharides, more preferable at least 99.5%. Glycerol provides a particularly unpleasant off-taste and it is preferred that the syrup contains less than 2% glycerol by weight, preferably less than 0.5%.

Preferably the syrup and particles are combined in step (iii) in a weight ratio of syrup:particles of between 4:1 to 0.7:1, more preferably of between 3:1 to 1:1, even more preferably of between 2.5:1 to 1.5:1.

According to a second aspect of the invention there is provided a frozen product in a container suitable for use in the methods of this invention. The container comprises a wall delimiting a cavity; the frozen product being within the cavity and at least a first section of the wall being deformable by hand pressure. The frozen product is transformable, at a temperature of from −10° C. to −8° C., preferably −10° C., from a non-drinkable state to a drinkable state by manually deforming the first section of the wall for a period of between 10 and 200 s, preferably between 30 and 100 s, more preferably not more than 60 s.

We have found that such a frozen product can be filled into a container more fully than prior art products that require shaking of the container in order to effect transformation to a drinkable state. In addition, the ability of the product to be transformed by manual deformation allows for more rapid transformation than shaking the container or even directly stirring the product.

Also, as the frozen products according to the present invention are relatively rigid at temperatures of around −10° C. and below, they are much more stable during distribution and storage than some prior-art products formulated to be transformable at lower temperatures or by other, less efficient, methods. Furthermore, frozen products according to this invention are generally more palatable than prior art products formulated to be transformable at lower temperatures as there is no need for special formulations with high levels of additives such as calcium components (e.g. dicalcium phosphate), alcohols or sugar alcohols.

The frozen products for use in the methods of the present invention may or may not be aerated depending on the desired textural characteristics of the resulting slushy drink. In a preferred embodiment the frozen product has an overrun of between 5 and 80%, preferably between 10 and 60, more preferably in the range of 10 to 50%. Non-aerated products have an overrun below 5%.

The frozen product may be a milkshake precursor; i.e. it may be transformed into a milkshake by manually deforming the container. Alternatively, the frozen product may be a smoothie precursor or a frappe precursor.

Preferably the frozen product contains freezing point depressants in an amount from 20 to 40% (w/w), more preferably from 22 to 32%. Preferably also, the freezing point depressants have a number average molecular weight below 275 g mol⁻¹, more preferably below 250 g mol⁻¹. Even more preferably the freezing point depressants have a number average molecular weight in the range 210 to 245 g mol⁻¹. Such formulations are found to allow for easy transformation to a drinkable state without imparting too sweet a taste to the product. In order to minimise off-flavours it is preferable that the freezing point depressants consist of at least 98% by weight of mono-, di- and oligosaccharides, more preferable at least 99.5%. Glycerol provides a particularly unpleasant off-taste and it is preferred that the frozen product contains less than 1.5% glycerol by weight, preferably less than 0.2%, more preferably less than 0.05%.

The frozen product preferably contains a stabiliser in an amount from 0.001 to 2% (w/w), preferably from 0.01 to 1%, more preferably 0.05 to 0.5%. Suitable stabilisers include carboxymethyl cellulose (CMC), iota-carrageenan, kappa-carrageenan, lambda-carrageenan, modified starches, pectins, alginates, maltodextrins, micro-crystalline cellulose (MCC), guar gum, xanthan gum, locust bean gum, gelatin and mixtures thereof. Preferably, the stabiliser is selected from CMC, iota-carrageenan, xanthan gum and mixtures thereof, more preferably iota-carrageenan, xanthan gum and mixtures thereof as these stabilisers are found to give good stability while not imparting too high a viscosity during drinking.

The frozen product may contain an emulsifier in an amount from 0.001 to 2% (w/w), preferably from 0.01 to 1%, more preferably 0.05 to 0.5%. Suitable emulsifiers are well-known in the art and include monoglycerides, diglycerides, organic acid esters (e.g. lactic acid esters, citric acid esters etc.), polysorbates and mixtures thereof.

In a preferred embodiment the product contains fat in an amount from 0.5 to 12% (w/w), preferably from 1 to 10%. In an alternative preferred embodiment the product contains less than 0.5% fat, preferably between 0.01 and 0.1% fat. Examples of sources of fat include milk, butterfat, vegetable fat (such as coconut oil) and combinations thereof.

The frozen product may contain milk proteins. Preferably the milk proteins are in an amount of between 0.5 and 5% (w/w), more preferably of between 0.7 and 4%. Examples of sources of milk proteins include milk, concentrated milk, milk powder, yoghurt, whey and whey powder. Preferably the amount of milk protein is not too high as this imparts a chalky texture to the product. Alternatively, the product may be a substantially non-dairy product and contain less than 0.5% milk protein.

It is preferable that the frozen products and slushy drinks of this invention are non-alcoholic. That is that they contain less than 0.5% (w/w) alcohol, more preferably less than 0.1% (w/w). This is because alcohol unduly depresses the freezing point making the products less icy and less stable than is desirable. Also alcohol destabilises any milk proteins or fat droplets present in the products.

Preferably the mass of frozen product in the container is that of a single serving. More preferably the mass is between 50 and 500 g, even more preferably between 150 and 350 g.

Preferably the frozen product has an ice particle size distribution characterised by at least 25% by number of the ice particles having a size of greater than 12. More preferably at least 30% by number of the ice particles have a size of greater than 1 mm², and even more preferably at least 40%. Preferably also, at least 99% of the particles have a size below 30 mm². More preferably, substantially all of the particles (e.g. 99.9%) have a size below 20 mm². Products with such a structure are found to provide an authentic freshly-made slush texture, with orally detectable ice particles, while displaying excellent drinkability.

In one preferred embodiment of the invention, the first section of the container wall comprises a flexible pouch or tube.

Suitable beverage pouches are known in the art and often comprise foil laminate material. Suitable tubes used for dispensing viscous gels and pastes are also known in the art and often comprise LDPE. In an alternative preferred embodiment,, the container wall comprises a bottle with a top end and a bottom end with the first section comprising a tubular portion disposed between the ends. Suitably the bottle is formed (e.g blow-moulded) from a flexible plastic material such as polyethylene terephthalate (PET), polyethylene (PE) and/or polypropylene (PP).

Preferably the container has a brim full capacity of between 50 ml and 1000 ml, more preferably between 100 and 600 ml, even more preferably between 150 and 400 ml. Preferably also, the container is of a size to be easily gripped in one hand of a user, more preferably the container is shaped to fit in the hand. The first section may be ribbed to reduce the surface area of the container in contact with the hand and thus reduce the cold feeling generated therein by holding the container.

In a particularly preferred embodiment of the invention the container additionally comprises a straw. We have found that for products consumed using a straw of any geometry, the parameter of flow rate determines the acceptability to the consumer. The product must flow through the straw at a rate of at least 1.75 g s⁻¹, preferably at a rate of at least 2.5 g s⁻¹, for this mode of consumption to provide consumer satisfaction. In particularly preferred embodiments the flow rate lies in the range 1.75 g s⁻¹ to 3 g s⁻¹, preferably 2 to 3 g s⁻¹.

According to a third aspect of the invention there is provided a frozen product containing ice particles wherein the ice particle size distribution is characterised by at least 25% by number of the ice particles having a size of greater than 1 mm². More preferably at least 30% by number of the ice particles have a size of greater than 1 mm², and even more preferably at least 40%. Preferably also, at least 99% of the particles have a size below 30 mm². More preferably, substantially all of the particles (e.g. 99.9%) have a size below 20 mm². Preferably also, substantially all of the ice particles have a size greater than 0.25 mm². The number mean ice particle size is preferably in the range 0.3 to 4 mm, more preferably 0.7 to 3 mm. Products with such a structure are found to provide an authentic freshly-made slush texture, with orally detectable ice particles, while displaying excellent drinkability.

### BRIEF DESCRIPTION OF THE DRAWINGS

The present invention is described by way of example with reference to the accompanying drawings in which:

FIG. 1a is a frontal elevation of a container for use in an embodiment of the invention;

FIG. 1b is a sectional side elevation of the container of FIG. 1a;

FIG. 2a is an elevation of a container for use in a further embodiment of the invention;

FIG. 2b is a sectional elevation of the container of FIG. 2a;

FIG. 3a is a sectional view of a size-reduction device comprising parallel plates for use in an embodiment of the invention;

FIG. 3b is a plan view of the fixed (bottom) plate of the size-reduction device of FIG. 3a; and

FIG. 3c is a plan view of the rotating (top) plate of the size-reduction device of FIG. 3a.

### DETAILED DESCRIPTION OF THE INVENTION

The present invention will now be described with reference to the following non-limiting examples.

### EXAMPLE 1

In this example, various modes of transforming a frozen product into a slushy drink were evaluated. Four modes of transformation were evaluated: stirring, shaking, squeezing and kneading.

### Containers

The containers used for the stirring tests were simple plastic cups (PET high-clarity tumblers supplied by Huhtamaki, Ronsberg, Germany) having a brim full capacity of 290 ml. These containers are referred to as Container A.

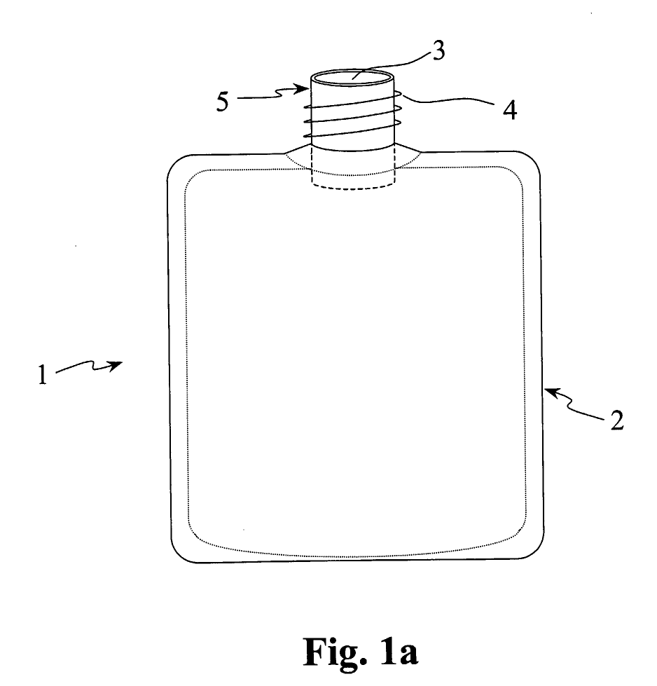

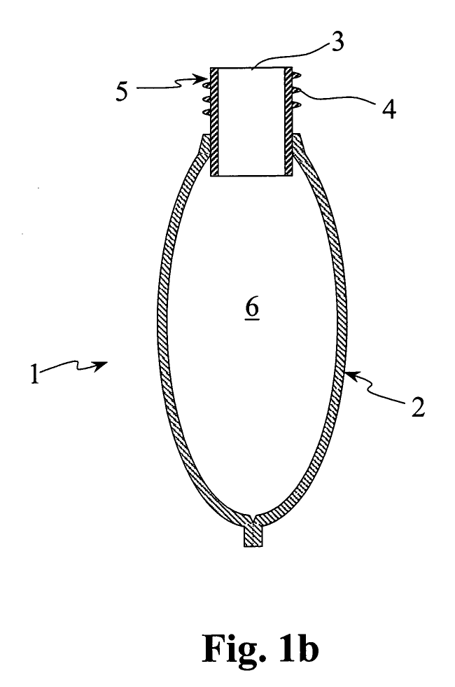

FIGS. 1a and 1b show a container (1) similar to those used for the kneading tests. The container (1) comprises a flexible pouch or tube (2) forming a wall delimiting a cavity (6). The pouch (2) is in sealing engagement with a spout (5) which has a product outlet (3) in fluid communication with the cavity (6) and is threaded (4) to receive a sealing cap (not shown). The containers used in the tests were flexible LDPE tubes as used for applying Vanish™ stain remover gel (Reckitt Benckiser, Mannheim, Germany) and having a brim full capacity of 235 ml. These containers are referred to as Container B.

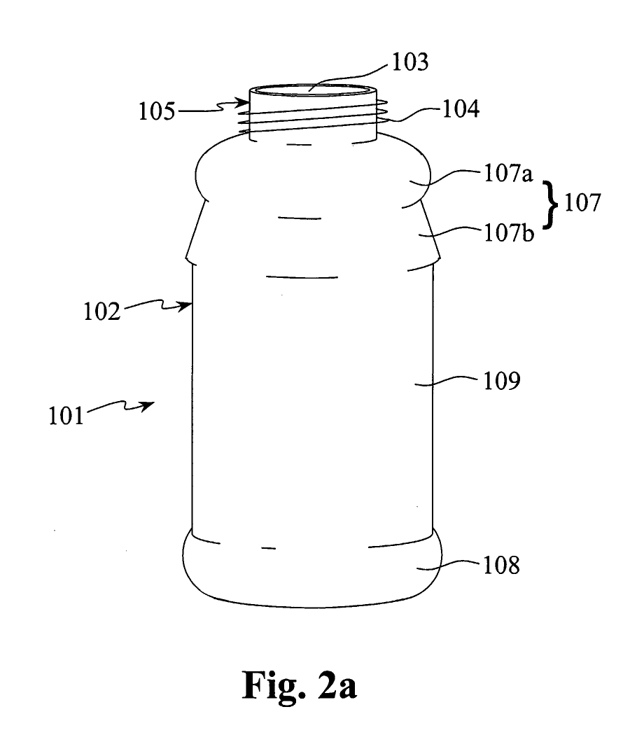

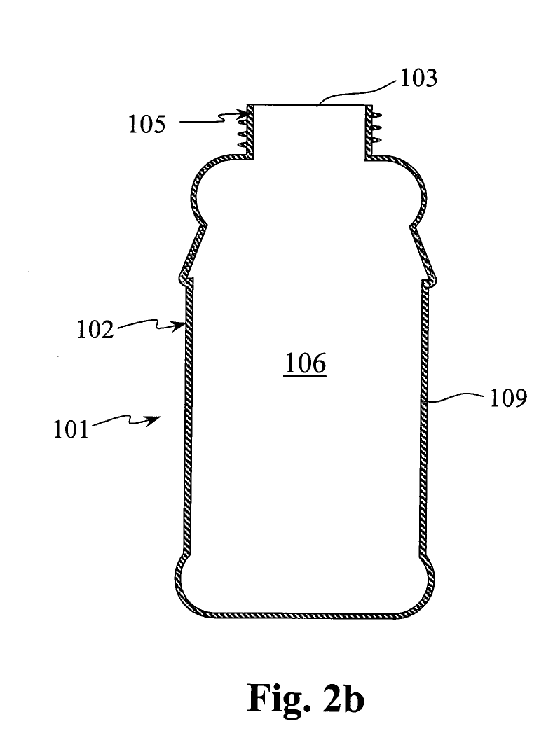

FIGS. 2a and 2b show a container (101) similar to those used for both the shaking and squeezing tests. The container (101) comprises a blow-moulded plastic bottle (102) which is substantially circular in cross-section and forms a wall delimiting a cavity (106). The bottle (102) has a cylindrical spout (105) which comprises a product outlet (103) in fluid communication with the cavity (106) and is threaded (104) to receive a sealing cap (not shown). The spout (105) is integral with the top section (107) of the bottle which comprises a bulbous portion (107a) coaxial with and extending upwards from a frusto-conical section (107b). Coaxial with the top section (107) is a bowl-shaped end section (108) and extending there-between a tubular first section (109). For the squeezing tests the containers used were flexible PET bottles having a brim full capacity of 270 ml. These containers are referred to as Container C. For the shaking tests, four types of PET bottle were used having brim full capacities of 316, 347, 396, and 526 ml. These containers are referred to as Container D1, D2, D3 and D4 respectively.

### Formulations

All concentrations are given on a w/w basis.

Specialist materials were as follows:
Xanthan gum was Keltrol™ supplied by CP Kelco (Lille Skensved, Denmark) and had a moisture level of less than 14%.
Low Fructose Corn Syrup was C*TruSweet 017Y4, had a moisture level of 22%, a DE of 63 and was supplied by Cerester, Manchester, UK.

A peach tea flavoured frozen product was prepared by combining a syrup with ice particles. The formulations of the syrup and the final frozen product are given in Table I.

TABLE I

| | Syrup | Frozen Product |
|---|---|---|
| Low Fructose Corn Syrup (%) | 26.00 | 13.00 |
| Dextrose Monohydrate (%) | 28.00 | 14.00 |
| Xanthan gum (%) | 0.30 | 0.15 |
| Citric Acid (%) | 1.20 | 0.60 |
| Malic Acid (%) | 0.20 | 0.10 |
| Peach Flavour (%) | 0.90 | 0.45 |
| Tea Solids (%) | 0.14 | 0.07 |
| Water (%) | 43.26 | 71.63 |
| FPDS (%) | 45.7 | 22.9 |
| <M>ₙ (g mol⁻¹) | 216 | 216 |

### Preparation of Syrup

All ingredients except for the flavour and acids were combined in an agitated heated mix tank and subjected to high shear mixing at a temperature of 65° C. for 2 minutes. The resulting mix was then passed through a homogeniser at 150 bar and 70° C. followed by pasteurisation at 83° C. for 20 s and rapid cooling to 4° C. using a plate heat exchanger. The flavour and acids were then added to the mix and the resulting syrup held at 4° C. in an agitated tank for a period of around 4 hours prior to freezing.

### Preparation of Ice Particles

A Ziegra Micro Ice machine (ZIEGRA-Eismaschinen GmbH, Isernhagen, Germany) was used to manufacture ice particles measuring approximately 5×5×2-7 mm.

### Manufacture of Slush

The syrup was frozen using a typical ice cream freezer (scraped surface heat exchanger) operating with an open dasher (series 80), a mix flow rate of 120 1/hour, an extrusion temperature of −14° C. and an overrun at the freezer outlet of less than 10%.

Immediately upon exit from the freezer, the ice particles were fed into the stream of frozen syrup using a fruit feeder (star wheel or vane type) to form a slush. The rate of addition of ice particles was controlled such that the syrup:particle ratio was 1:1 (i.e. 50% ice particles by total weight of slush).

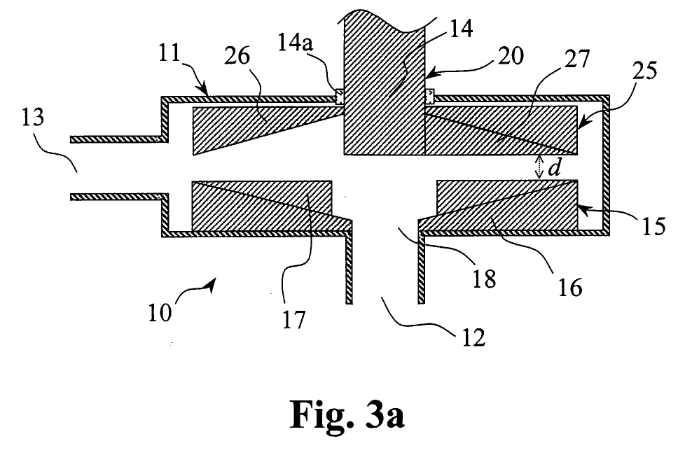

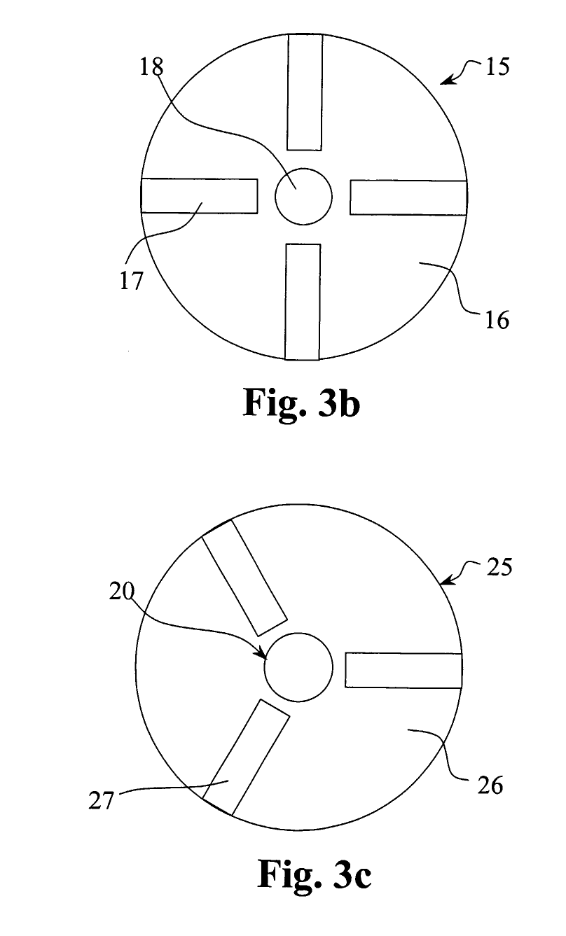

The slush was then passed through a size-reduction device. The size-reduction device (10) is schematically illustrated in FIGS. 3a to 3c and comprises the drive (20) and casing (11) of a centrifugal pump (APV Puma pump supplied by Invensys APV, Crawley, UK).

The generally cylindrical casing (11) has a tubular outlet (13) disposed at its edge and has a tubular inlet (12) located centrally in its base. Opposite the inlet (12) and located in the centre of the top of the casing (11) is an aperture (14) for receiving the drive shaft (20) of the centrifugal pump. The drive shaft (20) is in sealing engagement with the casing (11) owing to the presence of an annular seal (14a) located there between.

Located within the casing (11) is a pair of parallel plates (15, 25), being coaxially aligned with the casing (11) and spaced longitudinally from each other by a distance, d. The lower plate (15) is fixedly attached to the base of the casing (11) whilst the upper plate (25) is fixedly attached to the drive shaft (20). By means of its attachment to the drive shaft (20) the upper plate (25) is rotatable relative to the casing (11). In contrast, the lower plate (15) is stationary owing to its attachment to the casing (11).

The lower plate (15) comprises a disc (16) having a central aperture (18) there through which is in fluid communication with the inlet (12) of the casing (11). The whole of the bottom surface of the disc (16) is flat and in contact with the base of the casing (11). The top surface of the disc (16) tapers radially inwards towards the central aperture (18). Projecting upwards from the top surface of the disc (16) are a plurality, for example four, fins (17) spaced regularly around the circumference of the plate (15). Each fin (17) has an upper surface that extends radially inward from, and remains at a height level with, the outer edge of the top surface of the disc (16).

The upper plate (25) is similar to the lower plate (15) but inverted such that it is the top surface of the disc (26) that is flat and the bottom surface tapered. The central aperture of the disc (26) of the upper plate receives the drive shaft (20) and the top surface of the disc (26) is slightly spaced longitudinally from the top of the casing (11) to allow the plate (25) to rotate freely. The top plate (25) may be provided with a different arrangement of fins to the lower plate (15) and in this case the upper plate (25) has three fins (27) whilst the lower (15) has four fins (17).

The size-reduction device (10) is arranged such that slush pumped in through the inlet (12) is required to pass between the parallel plates (15, 25) before it can exit through the outlet (13). The narrow spacing (d) of the plates along with the grinding action of the fins (27) on the rotating top plate (25) against the fins (17) of the bottom plate (15) ensures that the ice particles passing through the device have a maximum length of less than d in at least one dimension.

In this example the size-reduction device had a constriction size, d, of 2.5 mm.

Following size-reduction, the slush was dosed into containers in the quantities given in Table II. At the dosing stage the slush had a temperature of about −6° C. The containers were then capped and placed in a blast freezer (−35° C.) for around four hours wherein the slush hardened to form the frozen product.

TABLE II

| | Brim full Capacity | Fill Volume | Fill Volume |
|---|---|---|---|
| Container | (ml) | (ml) | (% of brim full) |
| A | 290 | 233 | 81 |
| B | 235 | 191 | 81 |
| C | 270 | 229 | 85 |
| D1 | 316 | 238 | 75 |
| D2 | 347 | 229 | 66 |
| D3 | 396 | 238 | 60 |
| D4 | 526 | 241 | 46 |

### Storage

The frozen products in the containers were stored at a temperature of −25° C. for approximately one week following removal from the blast freezer. This is similar to the temperature that would be employed when transporting commercial samples from the hardening location to a retail outlet.

### Tempering

The frozen products in the containers were tempered to −10° C. by storage for 24 hours in a freezer cabinet operating at −10° C.

### Transformation Tests

Each frozen product was removed from the −10° C. cabinet into a room having an ambient temperature of +20° C. and immediately tested. The test duration was 60 s, at which time a straw was inserted into the centre of the product and drinkability assessed on a scale of 1 to 7, wherein a score of 1 represented very difficult, 4 represented drinkable and 7 represented very easy to drink. The tests were as follows:

STIRRING: The cap was removed from the cup and a straw forced into the frozen product within the cup. The straw was then used to stir the product. Often, the straw would have to be intermittently removed and re-inserted at a different position to prevent the product simply rotating within the cup.

KNEADING: With the cap in place, the container was gripped in both hands such that the fingers and thumbs were substantially around the first section (2). The grip was then tightened and the container worked by twisting, folding and pressing.

SQUEEZING: With the cap in place, the container was gripped in both hands such that the fingers and thumbs were substantially around the first section (109). The grip was then rhythmically tightened and released to crush the product within the container. Intermittent inversion of the container was required to move remaining solid portions of the product into the vicinity of the first section (109).

SHAKING: With the cap in place, the container was gripped in one or both hands about the first section (109) and then shaken continually by rapidly moving it up and down by a distance of about 30 cm.

### Results

The results of the tests are given in Table III.

TABLE III

| Transformation Mode | Container Type | Drinkability (60 s) |
|---|---|---|
| Stirring | A | 2 |
| Kneading | B | 4 |
| Squeezing | C | 3 |
| Shaking | D1 | 2 |
| | D2 | 1 |
| | D3 | 4 |
| | D4 | 4 |

It is apparent from these tests that both squeezing and kneading are more efficient modes of transforming a frozen product into a slushy drink than is stirring. It is also apparent that shaking is only effective when the container is only part-filled (i.e. less than 66% fill volume).

### Example 2

In this example two fruit-based smoothies according to the invention are described.

### Containers

All products were packaged in PET bottles having a brim full capacity of 250 ml and similar to the container shown in FIG. 2.

### Formulations

All concentrations are given on a w/w basis.

Specialist materials were as follows:
Low Fructose Corn Syrup was C*TruSweet 017Y4, had a moisture level of 22%, a DE of 63 and was supplied by Cerester, Manchester, UK.
Whey Powder was Avonol™ 600 Whey powder supplied by Glanbia Ingredients (Ballyragget, Co. Kilkenny, Ireland), and has a moisture content 3.7%, a lactose content of 53% and a protein content of 31%.
Strawberry Puree was supplied by SVZ International BV (Holland) and was an aseptically filled, seedless, single-strength puree having a water content of 89%, a sucrose content of 0.9%, a dextrose content of 2.2% and a fructose content of 2.3%.
Iota Carrageenan was Deltagel™ P388, supplied by Quest International (Bromborough Port, UK) and had a moisture content of less than 10%.
Guar Gum was supplied by Willy Benecke (Hanburg, Germany) and had a moisture content below 14%.
Monoglyceride emulsifier was ADMUL MG 40-04 supplied by Quest International, Bromborough Port, UK.
Yoghurt was supplied by Delicelait (Normandy, France) and had 3.5% fat, 3.8% protein and 4.9% galactose.

The smoothies were prepared by combining syrups with ice particles. The formulations of the syrups and the final frozen products are given in Table IV.

TABLE IV

| | Smoothie E | | Smoothie F | |
|---|---|---|---|---|
| | | Frozen | | Frozen |
| | Syrup | Product | Syrup | Product |
| Dextrose Monohydrate (%) | 14.90 | 10.43 | 15.30 | 9.94 |
| Low Fructose Corn Syrup (%) | 30.50 | 21.35 | 21.40 | 13.91 |
| Skimmed Milk Powder (%) | 1.70 | 1.19 | 4.60 | 3.00 |
| Whey Powder (%) | 1.70 | 1.19 | 6.70 | 4.36 |
| Coconut Oil (%) | 1.10 | 0.77 | 4.60 | 3.00 |
| Iota Carrageenan (%) | 0.14 | 0.10 | 0.15 | 0.10 |
| Guar Gum (%) | 0.07 | 0.05 | 0.08 | 0.05 |
| Monoglyceride Emulsifier(%) | 0.20 | 0.14 | 0.23 | 0.15 |
| Yoghurt (%) | 12.00 | 8.40 | — | — |
| Strawberry Puree (%) | 20.00 | 14.00 | 23.00 | 14.95 |
| Beetroot Red Colour (%) | 0.10 | 0.07 | 0.10 | 0.07 |
| Citric Acid (%) | 0.12 | 0.08 | 0.15 | 0.10 |
| Flavour (%) | 0.12 | 0.08 | 0.15 | 0.10 |
| Water (%) | 17.35 | 42.15 | 23.54 | 50.27 |
| FPDS (%) | 40.7 | 28.5 | 37.5 | 24.4 |
| <M>ₙ (g mol⁻¹) | 236 | 236 | 237 | 237 |

### Preparation of Frozen Products

The frozen products were prepared as in Example 1, except for the ingredients added following rapid cooling of the mix, the amount of overrun whipped into the syrup during freezing, the amount of ice particles combined with the syrup and the size of the constriction, d, used in the size-reduction device.

For both smoothies, the strawberry puree as well as the acids and flavours were added post-pasteurisation. For smoothie E, the yoghurt was also added post-pasteurisation.

For both smoothies the overrun of the syrup at the freezer outlet was around 50%; which gave a final product overrun of around 30%.

For both smoothies the constriction size, d, was 2 mm.

For smoothie E, the syrup and ice particles were combined in a weight ratio of 2.33 syrup : 1 ice (i.e. 30% w/w ice particles on total product). For smoothie F, the ratio was 1.86 syrup : 1 ice (i.e. 35% w/w ice particles on total product). For both smoothies the fill volume was 230 ml.

### Example 3

This example describes a milkshake according to the invention.

### Container

The container used was as in Example 2.

### Formulation

All concentrations are given on a w/w basis. Specialist materials were as in Example 2.

A strawberry flavoured frozen product was prepared having the formulation given in Table V.

TABLE V

| | Milkshake |
|---|---|
| Dextrose Monohydrate (%) | 12.60 |
| Low Fructose Corn Syrup (%) | 14.10 |
| Skimmed Milk Powder (%) | 4.00 |
| Whey Powder (%) | 4.40 |
| Coconut Oil (%) | 8.00 |
| Iota Carrageenan (%) | 0.12 |
| Guar Gum (%) | 0.10 |
| Monoglyceride Emulsifier(%) | 0.30 |
| Strawberry Puree (%) | 15.00 |
| Beetroot Red Colour (%) | 0.10 |
| Citric Acid (%) | 0.15 |
| Flavour (%) | 0.12 |
| Water (%) | 41.01 |
| FPDS (%) | 27.5 |
| <M>ₙ (g mol⁻¹) | 232 |

### Slush Manufacture

All ingredients except for the puree, flavour, acids, fat and emulsifiers were combined in an agitated heated mix tank. The fat was then melted and emulsifiers added to the liquid fat prior to pouring into the mix tank. The mix was subjected to high shear mixing at a temperature of 65° C. for 2 minutes. The mix was then passed through a homogeniser at 150 bar and 70° C. and then subjected to pasteurisation at 83° C. for 20 s before being rapidly cooled to 4° C. by passing through a plate heat exchanger. The puree, flavour and acids were then added and the mix held at 4° C. in an agitated tank prior to freezing.

The mix was frozen into a slush using a typical ice cream freezer operating with an open dasher (series 80), a mix flow rate of 150 1/hour, an extrusion temperature of −12° C. and an overrun of 50%.

### Filling and Hardening

The slush exiting the freezer was dosed into the containers at a fill volume of 230 ml. The containers were then capped and then blast frozen for 4 hours at −35° C.

### Transportation

The products were stored at −25° C. for 1 week and then transported from the hardening location in Bedfordshire, UK to a second location in Rome, Italy. Transportation was via refrigerated lorry operating at a temperature of −20° C.

### Tempering

At the second location the products were stored for 7 days in a freezer cabinet operating at −10° C. No phase separation, shrinkage or other instability is apparent in the products following such storage and distribution.

### Transformation

The products were removed from the freezer cabinet and transformed into a drinkable state by squeezing and kneading the containers for around 60-90 s. The caps were then removed from the containers and the resulting milkshakes drunk from the containers.

1. A method of serving a slushy drink comprising the steps of:
manufacturing a slush, then
filling a container with the slush, then
hardening the slush at a hardening location to produce a frozen product in the container, then
transporting the frozen product in the container from the hardening location through a cold chain to a retail outlet, then
warming the frozen product in the container at the retail outlet to a temperature, T, of between −14 and −5° C., and then
transforming the frozen product in the container into the slushy drink;
characterised in that the volume of the frozen product in the container is at least 70%, preferably at least 80% of the brim full capacity of the container.

2. A method according to claim 1 wherein the container is deformable by hand pressure.

3. A method according to claim 1 wherein the frozen product in the container is transformed into the slushy drink by deforming the container.

4. A method according to claim 3 wherein the frozen product in the container is transformed into the slushy drink by manually deforming the container.

5. A method according to claim 4 wherein manually deforming the container involves a mode selected from squeezing, kneading and combinations thereof.

6. A method according to claim 1 wherein T is between −12 and −6° C.

7. A method according to claim 1 wherein the step of warming the frozen product in the container is achieved by tempering the frozen product at the temperature T.

8. A method according to claim 1 wherein the slush is manufactured by a process comprising the steps of:
providing an aqueous syrup comprising freezing point depressants,
providing particles of ice, and
combining the aqueous syrup with the particles of ice to form the slush.

9. A method according to claim 8 wherein the process comprises the additional step of reducing the ice particle size in the slush.

10. A method according to claim 9 wherein the additional step of reducing the ice particle size in the slush comprises passing the slush through a constriction of less than 5 mm, preferably of between 0.5 and 3 mm.

11. A frozen product in a container, the container (1, 101) comprising a wall (2, 102) delimiting a cavity (6, 106), the frozen product being within the cavity and at least a first section (2, 109) of the wall being deformable by hand pressure; characterised in that, at a temperature in the range −10° C. to −8° C., the frozen product is transformable from a non-drinkable to a drinkable state by manually deforming the first section of the wall for a period of between 10 and 200 s, preferably for a period of between 30 and 100 s.

12. A frozen product in a container according to claim 11 wherein the volume of the frozen product is at least 70%, preferably at least 80% of the brim full capacity of the container.

13. A frozen product in a container according to claim 11 wherein the frozen product has an overrun of less than 5%.

14. A frozen product in a container according to claim 11 wherein the frozen product has an overrun between 5 and 80%.

15. A frozen product in a container according to claim 11 wherein the frozen product contains freezing point depressants in an amount from 20 to 40% (w/w), the freezing point depressants having a number average molecular weight below 275 g mol⁻¹.

16. A frozen product in a container according to claim 11 wherein the frozen product contains less than 1.5% glycerol, preferably less than 0.2%.

17. A frozen product in a container according to claim 11 wherein the frozen product contains from 0.001 to 2% (w/w) of a stabiliser selected from iota-carrageenan, xanthan gum and mixtures thereof.

18. A frozen product in a container according to claim 11 wherein the frozen product contains fat in an amount from 0.5 to 12% (w/w).

19. A frozen product in a container according to claim 11 wherein the frozen product contains less than 0.5% (w/w) fat.

20. A frozen product in a container according to claim 11 wherein the frozen product contains one or more milk proteins in an amount of between 0.5 and 5% (w/w).

21. A frozen product in a container according to claim 11 wherein the frozen product contains less than 0.5% (w/w) milk protein.

22. A frozen product in a container according to claim 11 wherein the frozen product contains ice particles having a size distribution wherein at least 25% by number of the ice particles have a size of greater than 1 mm².

23. A frozen product in a container according to claim 11 wherein the container additionally comprises a straw and the frozen product transformed to a drinkable state has a flow rate through the straw of at least 1.75 g s⁻¹.
